(19) United States
(12) Patent Application Publication
(10) Pub. No.: US 2026/0360264 A1
(43) Pub. Date: Nov. 12, 2026

(54) Aircraft traffic separation assistance system and related methods

(71) Applicant: Digital Copilot, Inc., Los Altos, CA (US)

(72) Inventor: Charles J. Rothschild, Los Altos, CA (US)

(21) Appl. No.: 19/563,115

(22) Filed: Mar. 11, 2026

Related U.S. Application Data
(60) Provisional application No. 63/772,028, filed on Mar. 14, 2025.

(51) Int. Cl. G08G 5/80; G08G 5/54; G08G 5/72; G08G 5/78

(52) U.S. Cl. CPC G08G 5/80; G08G 5/54; G08G 5/727; G08G 5/78

(57) ABSTRACT

A method and system for aircraft traffic separation assistance involving receiving state information for multiple aircraft, defining a grid of airspace elements around a runway, and identifying specific airspace elements occupied by aircraft. The system retrieves rules associated with these elements to determine the probability of aircraft following various paths and calculates four-dimensional trajectories. These trajectories are compared to identify potential conflicts when aircraft are predicted to violate separation minima. The system can be installed in aircraft or at airports and includes features for generating warnings and alerts.

### CROSS REFERENCE TO RELATED APPLICATIONS

This application claims priority to non-provisional patent application No. 63/772,028 filed on Mar. 14, 2025, the entirety of which is incorporated herein by reference.

### FIELD

This application relates to an air traffic system and specifically to a system and method for calculating and comparing 4D trajectories to identify potential conflicts when aircraft are predicted to violate separation minima.

### BACKGROUND

Air traffic management is a critical component of modern aviation, ensuring the safe and efficient movement of aircraft through increasingly crowded skies. The complexity of managing air traffic is compounded by the need to accommodate a wide range of aircraft types, each with distinct performance characteristics and operational requirements, and operations into and out of a wide variety of airports. Traditional air traffic control systems rely heavily on predefined procedural paths and manual intervention by air traffic controllers to maintain safe separation between aircraft. However, as air traffic volumes continue to grow, there is a pressing need for more advanced systems that can predict and manage aircraft trajectories with greater accuracy and reliability.

Safe air traffic separation can be particularly challenging near airports due to the higher aircraft density, their proximity to the ground, and the fact that all planes are either arriving at or departing from the same location. The lack of air traffic control at many US airports often worsens this complexity.

Existing systems and procedures for aircraft traffic separation typically rely on standard procedural paths—predetermined routes that aircraft are expected to follow during the takeoff, landing, and en route phases of flight. These systems often use linear extrapolation of an aircraft's current track to predict future positions. However, this method can be inadequate in dynamic environments, such as those near airports, where deviations from standard paths are common. The limitations of these systems become particularly evident in complex airspace, where multiple aircraft operate in close proximity, increasing the risk of mid-air collisions.

Existing systems may include various methods and systems designed to enhance situational awareness and collision avoidance. For example, some systems utilize Automatic Dependent Surveillance-Broadcast (ADS-B) technology to provide real-time tracking of aircraft positions. However, while ADS-B significantly improves tracking accuracy over traditional surveillance radar, most current systems typically do not use this data to issue advanced warnings of potential future flight-path conflicts.

Some more sophisticated systems rely only on linear extrapolation of an aircraft's current trajectory or depend solely on standard flight paths to identify possible conflicts.

The challenges posed by current air traffic management systems, especially in environments without air traffic control (ATC), such as airports without control towers, underscore the need for innovative solutions. In such cases, reliance on individual pilots to “see and avoid” potential conflicts is critical.

Therefore, it is essential to develop systems capable of dynamically predicting aircraft trajectories and identifying potential conflicts in real-time. These solutions must account for the inherent variability in aircraft operations, providing a flexible and robust approach to traffic separation. By moving beyond the constraints of procedural paths and simple extrapolation methods, new systems can enhance safety and efficiency in air traffic management, particularly in the critical airspace surrounding airports.

### SUMMARY

The present disclosure addresses the problem of identifying aircraft traffic separation for monitored aircraft departing and landing at a runway.

In some embodiments, a method for aircraft traffic separation assistance is provided. The method comprising partitioning airspace surrounding a runway into a runway grid comprising a plurality of discrete, non-overlapping airspace elements, storing, in a rules matrix database, a set of viable future paths rules and a set of projected path rules associated with each airspace element of the plurality of discrete, non-overlapping airspace elements, receiving state information for a monitored aircraft, wherein the state information comprises at least position data and track data, identifying a specific airspace element of the plurality of discrete, non-overlapping airspace elements that the monitored aircraft occupies based on the state information, retrieving, from the rules matrix database, the set of viable future paths rules and the set of projected path rules associated with the specific airspace element, applying the set of viable future paths rules to the state information to determine a plurality of viable path variants for the monitored aircraft, for each viable path variant of the plurality of viable path variants, applying the set of projected path rules to construct a corresponding four-dimensional trajectory, thereby generating a plurality of four-dimensional trajectories for the monitored aircraft, comparing the plurality of four-dimensional trajectories for the monitored aircraft with four-dimensional trajectories generated for other monitored aircraft to identify a conflict, wherein the conflict comprises a predicted violation of separation minima, and generating an alert in response to identifying the conflict.

In some embodiments, a system for aircraft traffic separation assistance is provided. The system comprising a processor, and a memory storing instructions that, when executed by the processor, cause the system to: define a runway grid comprising a plurality of discrete, non-overlapping airspace elements partitioning airspace surrounding a runway, maintain a rules matrix database storing, for each airspace element of the plurality of discrete, non-overlapping airspace elements, a set of viable future paths rules and a set of projected path rules, receive state information for a monitored aircraft, wherein the state information comprises at least position data and track data, determine a specific airspace element of the plurality of discrete, non-overlapping airspace elements occupied by the monitored aircraft based on the state information, retrieve, from the rules matrix database, the set of viable future paths rules and the set of projected path rules corresponding to the specific airspace element, apply the set of viable future paths rules to the state information to identify a plurality of viable path variants, for each viable path variant of the plurality of viable path variants, apply the set of projected path rules to generate a corresponding four-dimensional trajectory, thereby producing a plurality of four-dimensional trajectories for the monitored aircraft, compare the plurality of four-dimensional trajectories for the monitored aircraft against four-dimensional trajectories produced for other monitored aircraft to detect a conflict, wherein the conflict comprises a predicted violation of separation minima, and generate an alert upon detection of the conflict.

Still, other aspects, features, and advantages of this disclosure may be readily apparent from the following detailed description, as illustrated by several example embodiments. This disclosure may also be capable of other and different embodiments, and its several details may be modified in various respects. Accordingly, the drawings and descriptions are to be regarded as illustrative and not as restrictive.

### BRIEF DESCRIPTION OF THE DRAWINGS

FIG. 1 is a block diagram of an exemplary aviation data system implementing a method for traffic separation assistance in the vicinity of an airport, as disclosed herein.

FIG. 2 is a schematic representation of an exemplary runway grid for a runway at an airport as implemented within a system for traffic separation assistance in the vicinity of an airport, as disclosed herein.

FIG. 3 is a tabular representation of viable future paths rules as applied for each path to or from a runway as implemented within a system for traffic separation assistance in the vicinity of an airport, as disclosed herein.

FIG. 4 is a tabular representation of a projected path rules matrix for a future viable path to or from a runway as implemented within a system for traffic separation assistance in the vicinity of an airport, as disclosed herein.

FIG. 5 is a flow diagram of a method 500 for tracking and reporting target aircraft possibly conflicting with an ownship landing at or departing from an airport for an ownship-based system or all monitored aircraft for an airport-based system as implemented within a system for traffic separation assistance in the vicinity of an airport, as disclosed herein.

FIG. 6 is a flow diagram of a method 600 for tracking, sequencing, and providing guidance to an ownship landing at an airport for an ownship-based system or all monitored aircraft for an airport-based system as implemented within a system for traffic separation assistance in the vicinity of an airport, as disclosed herein.

FIG. 7 is a flow diagram of a method 700 for providing final approach guidance to ownship for ownship-based systems or of any monitored aircraft for airport-based systems on the final approach to land on a runway at an airport, as implemented within a system for traffic separation assistance in the vicinity of an airport, as disclosed herein.

FIG. 8 is a flow diagram of a method 800 for providing a warning to ownship for ownship-based systems or to any monitored aircraft for airport-based systems about possible wake turbulence from large aircraft that will cross the aircraft's path. This system is based, as disclosed herein.

FIG. 9 is a hardware block diagram of an aviation data system 900 located in an ownship and implementing a method for traffic separation assistance in the vicinity of an airport, as disclosed herein.

FIG. 10 is a hardware block diagram of an aviation data system 1000 located in an airport and implementing a method for traffic separation assistance in the vicinity of an airport, as disclosed herein.

### DETAILED DESCRIPTION

The present disclosure relates to a method and system for aircraft traffic separation assistance, particularly for preventing collisions in the vicinity of airports.

The following detailed description is directed to certain specific embodiments of the disclosure. However, the disclosure can be embodied in a multitude of different ways as defined herein. In this description, reference is made to the drawings, in which like parts are designated by like numerals throughout.

The terminology used in the description presented herein is not intended to be interpreted in any limited or restrictive manner, simply because it is being utilized in conjunction with a detailed description of certain specific embodiments. Furthermore, embodiments of the disclosure may include several features, no single one of which is solely responsible for its desirable attributes or for practicing the subject matter herein described.

Unless the context requires otherwise, throughout the specification which follows, the word “comprise” and variations thereof, such as “comprises” and “comprising” are to be construed in an open, inclusive sense, that is, as “including, but not to be limited to.” The word “coupled” or “connected”, as generally used herein, refers to two or more elements that may be either directly connected or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The headings provided herein are for convenience only and do not interpret the scope or meaning of the embodiments.

As used herein, the term “state information” refers to a set of data describing the current physical condition and movement of an aircraft. This may include, but is not limited to, a four-dimensional location (e.g., latitude, longitude, altitude, and a time-stamp), a track (i.e., the direction of motion over the ground), a climb/descent gradient or vertical speed, groundspeed (the speed the aircraft is traveling over the ground), turn rate (the direction and rate at which the aircraft is turning) and an aircraft identifier. State information is typically received from sources such as Automatic Dependent Surveillance-Broadcast (ADS-B) systems, Traffic Information Service-Broadcast (TIS-B) systems, Global Positioning System (GPS) feeds, and any other navigational and surveillance systems known to a person of ordinary skill in the art.

As used herein, the term “altitude” refers to aircraft altitude in MSL, mean sea level.

As used herein, the term “altitude change gradient” (ACG) is the change in altitude, measured in feet over 1 nautical mile (6076 feet) of horizontal distance traveled.

As used herein, the term “runway grid” refers to a defined, structured partitioning of airspace surrounding a specific location, such as a runway. In the context of the present disclosure, a grid comprises a matrix of discrete, non-overlapping airspace elements. A runway grid may be used for both landing operations and takeoff operations.

As used herein, the term “airspace element” refers to a discrete, two-dimensional volume of airspace that is a constituent part of a runway grid. Each airspace element is associated with a specific location relative to a reference point (e.g., the center of a runway's landing threshold) and is linked to a specific set of rules in a rules matrix database.

As used herein, the term “rules matrix database” refers to a data store that contains sets of rules, each associated with a specific airspace element of a runway grid. The database maps each airspace element to corresponding viable future path rules and projected path rules. The rules may be part of a universal ruleset applicable to all runways or a custom ruleset tailored to a specific runway.

As used herein, the term “viable future paths rules” refers to a set of logical conditions or criteria that are applied to an aircraft's state information to determine the viability of that aircraft following one of a plurality of predefined general path variants. These rules are typically based on parameters such as the aircraft's altitude, track angle, altitude climb/descent gradient, groundspeed, and turn rate relative to the airspace element it occupies.

As used herein, the term “grid altitude” refers to the altitude of a monitored aircraft relative to the altitude of the runway end elevation in a landing or takeoff grid. For example, a monitored aircraft with a grid altitude of 1000′ is 1000′ above the runway end elevation altitude.

As used herein, the term “runway end elevation” refers to the altitude in Mean Sea level at the landing zone of the specified runway end, as documented in the US Federal Aviation Administration's Aeronautical Information Services database

As used herein, the term “grid coordinates” means the mapping of an aircraft's latitude and longitude onto a runway grid and expressing the location in the grid coordinate system in the format of two real numbers, namely an X-axis coordinate and a Y-axis coordinate

As used herein, the term “groundspeed” refers to the speed the aircraft is traveling across the ground, as measured in Knots.

As used herein, the term “projected path rules” refers to a set of instructions or parameters used to construct a detailed four-dimensional trajectory for an aircraft taking off or landing from a runway, assuming it follows a specific general path variant. These rules may define reference lines, turn points, vertical profiles, and groundspeed parameters that model the expected flight path.

The term “general path,” as used in this context, refers to an area of airspace near a runway where an aircraft follows an approximate route from the beginning to the end of that area. For example, general landing paths may include left, right, and straight-in corridors.

The term “general path variant,” as used in this context, refers to one of multiple independent variations of a general path. The number of general path variants is an implementation detail, in which an aircraft follows an approximate route from the beginning to the end of that area. There may be a fixed number of variant paths for each general path. For example, there may be “n” variants, each variant labelled in ascending order up to “n”, e.g., each variant labelled as 1, 2, 3 . . . up to the fixed number “n.”

As used herein, the term “four-dimensional trajectory” or “4D Trajectory” refers to a predicted path of an aircraft through space and time. It is represented as a sequence of points, where each point comprises three spatial coordinates (e.g., latitude, longitude, and altitude) and a corresponding timestamp.

As used herein, the term “conflict” refers to a predicted event where two or more aircraft are forecast to be within a predefined horizontal separation minimum and a predefined vertical separation minimum at the same future time. The identification of a conflict indicates a potential loss of safe separation between aircraft.

As used herein, the term “separation minima” refers to the minimum required distances, both horizontally (“horizontal separation minimum”) and vertically (“vertical separation minimum”), that must be maintained between aircraft to ensure safety. These values can be configurable and may vary based on airspace class, aircraft speed, operational phase, and the specific needs of the implementation.

As used herein, the term “monitored aircraft” refers to any aircraft that is being tracked by the system.

As used herein, the term “ownship” refers to the monitored aircraft on which the disclosed system is installed and operating in an aircraft-based implementation. The term is used to distinguish this aircraft from other aircraft in the vicinity. There is no ownship in an airport-based implementation where the disclosed system is installed and operated in an airport-based implementation.

As used herein, the term “target aircraft” refers to any monitored aircraft other than the ownship.

As used herein, the term “heavy aircraft” refers to any monitored aircraft whose gross weight may be above a threshold weight.

As used herein, the term “airport” refers to the airport(s) that the ownship, in an aircraft-based implementation, has specified as a landing or departing airport(s). In the airport-based implementation, “airport” refers to the airport where the implementation is installed.

As used herein, the term “parallel runway” is defined as another runway at the same airport with a heading within 20 degrees of the runway associated with the current runway grid.

As used herein, the term “wake turbulence” refers to the disturbance in the atmosphere caused by the passage of an aircraft with a large gross weight, primarily created by the vortices generated at the wingtips during flight, which can pose hazards to following aircraft, especially during takeoff and landing.

The present disclosure provides systems and methods for aircraft traffic separation assistance, particularly in the complex and high-density airspace surrounding airport runways. The disclosed systems and methods depart from conventional conflict detection systems that rely on fixed, procedural flight paths or simple linear extrapolation. Instead, the disclosed system may employ a dynamic, probabilistic approach to predict a plurality of potential future flight paths for each aircraft based on its real-time state information and its location within a rule-based airspace structure.

The disclosed system may be a predictive system that models the airspace around a runway as a runway grid of discrete airspace elements. This runway grid serves as a framework for applying location-specific logic to predict an aircraft's intent. Based on an aircraft's continuously updated state information (latitude and longitude), the system may first identify which specific runway grid element the aircraft currently occupies.

For that specific runway grid element, the system may retrieve a corresponding set of rules from a rules matrix database. These rules may be divided into two types, namely viable future paths rules and projected path rules.

The viable future paths rules may be applied to the aircraft's current state to assess the viability that it will follow predefined general paths (e.g., left corridor, straight-in approach, straight-out departure) and their variants. These viable future paths rules may enable the system to independently assess the viability that the aircraft will follow each of the defined general path variants, based on its current behavior within a specific volume of airspace. As the pilot of a monitored aircraft can change the aircraft's path at any time, this system must continuously reevaluate all potential paths. The viable future paths rules evaluate each potential general path variant and determine whether it is a viable path to either a landing or a takeoff on a runway.

The projected path rules may provide the parameters to construct a detailed, physically plausible four-dimensional (4D) trajectory, comprising a series of points in space and time. A unique set of projected path rules may be applied to each general path variant deemed viable under the viable future path rules. By generating multiple potential 4D trajectories for each aircraft, the system creates a robust set of predictions that accounts for various possible pilot intentions and maneuvers, rather than being limited to a single expected path.

These predicted 4D trajectories for all aircraft in the vicinity may be continuously compared to identify conflicts.

If a conflict is determined, the system may generate appropriate warnings or alerts for a user, such as a pilot (in an in-aircraft based configuration) or an airport operator (in a airport based configuration).

Accordingly, the disclosed system may provide a robust, adaptable solution for predicting aircraft trajectories and identifying potential conflicts in real time. Specifically, by analyzing an aircraft's actual, real-time state within a geographically contextual ruleset, the system may more accurately predict future movements, especially when a pilot deviates from standard procedures, either intentionally or unintentionally, uses non-standard visual approaches, selects a different runway, or performs other unexpected maneuvers, such as an aborted landing. This dynamic, multi-path predictive capability provides a reliable, timely method for conflict detection, enhancing aviation safety during takeoff, landing, and terminal phases of flight.

The disclosed system and methods have been simulated using a system comprising off-the-shelf computing elements and historical aircraft tracking data. A 32×20 grid was developed with over 7500 combined elements in viability future path rules and projected future path rules matrices. The simulator inputs historical routes and simulates aircraft flying those routes, projecting future paths and conflicts at each point along the routes. The system has simulated over 100 historical flights, including 5 records of real mid-air collisions. The system accurately projected future 4D trajectories for each flight. In some cases, the system predicted up to 10 future 4D trajectories at various timestamps.

The system was capable of predicting conflicts well in advance. In the five real-world historical test cases, it provided between 119 and 210 seconds of warning. The most notable simulation involved a midair collision in January 2025 at Reagan Airport in Washington, D.C., which resulted in the deaths of 67 people. This simulation identified the conflict 141 seconds before the accident occurred.

In this complex scenario, the system generated up to seven simultaneous future 4D trajectories for the helicopter and up to nine simultaneous future 4D trajectories for the airliner. The portable iPad used in this simulation had sufficient processing power to recalculate each aircraft's future 4D trajectories in real time, in one-second increments, while utilizing less than 50% of the available computing resources. After downloading the historical data, the actual simulation ran offline, without any internet connection.

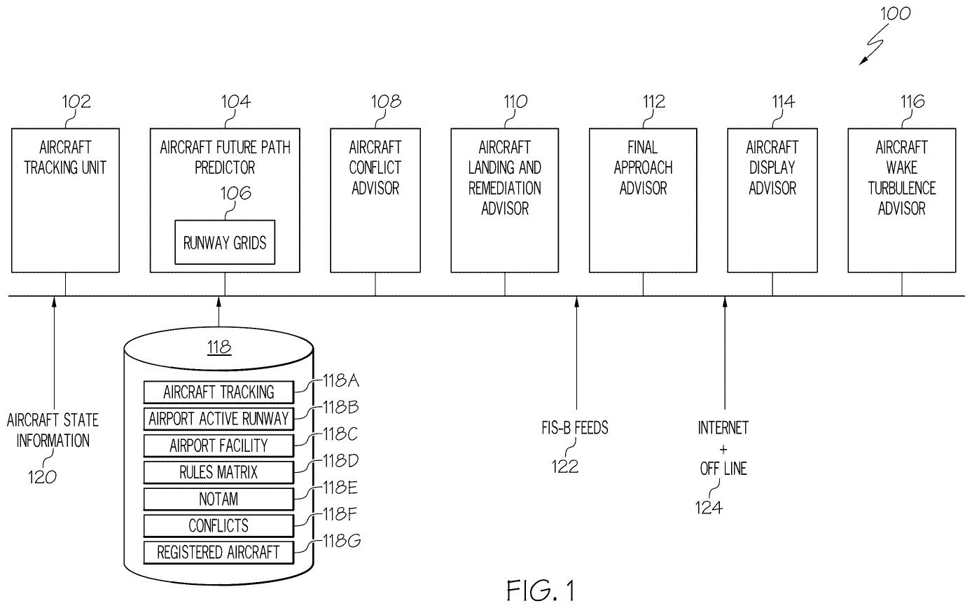

Referring now to the Drawings, FIG. 1 is a block diagram of an aviation data system 100 implementing a method for traffic separation assistance in the vicinity of an airport, as disclosed herein.

As shown in FIG. 1, the aviation data system 100 may include an aircraft tracking unit 102, an aircraft future path predictor unit 104, an aircraft conflict advisor unit 108, an aircraft landing and remediation advisor unit 110, a final approach advisor unit 112, an aircraft display advisor unit 114, an aircraft wake turbulence advisor unit 116, and databases 118.

The aircraft future path predictor unit 104 may include runway grids 106.

The aircraft tracking unit 102, aircraft future path predictor unit 104, aircraft conflict advisor unit 108, aircraft landing and remediation advisor unit 110, final approach advisor unit 112, an aircraft wake turbulence advisor unit 116, and aircraft display advisor unit 114 may be implemented using one or more processors and a memory storing instructions that, when executed by the processor, cause the system to perform the methods described herein. These elements may also be implemented as an integrated circuit (IC), such as an Application-Specific Integrated Circuit (ASIC). The ASIC may be a type of integrated circuit (IC) that is custom designed for a particular use or application, rather than intended for general-purpose use, such as a microprocessor.

The database 118 may be an organized collection of data that is stored and accessed electronically. It is designed to efficiently manage, store, and retrieve large amounts of information. The database 118 is structured to facilitate data storage while ensuring integrity, security, and ease of access. It may be managed using Database Management Systems (DBMS), which provide tools for defining, creating, querying, updating, and administering databases. The database 118 may be a relational database, organizing data into tables with rows and columns, or a non-relational database, such as a NoSQL database, which stores data in various formats, such as documents, key-value pairs, or graphs. While the data source may reside in a cloud-based system, when the system is operational, the database 118 may reside locally and not require network connectivity.

The database 118 may include an aircraft tracking database 1118A, an airport active runway database 118B, an airport facility database 118C, a registered aircraft database 118G, and a rules matrix database 118D.

The aircraft tracking database 118A may contain current, past state information, and predicted future 4D trajectory information on each tracked aircraft.

The airport active runway database 118B may contain information about a specific airport and the current usage of runways, including the timing of recent takeoffs and landings.

The aircraft tracking database 118A and the airport active runway database 118B may be dynamic databases updated and maintained by the aircraft tracking unit 102 and the aircraft future path predictor unit 104. These databases may or may not have persistent storage.

The airport facility database 118C may contain information on landing facilities, including details at both the facility and runway/heliport levels. This information may encompass attributes such as facility identification and precise runway locations, operational status and access, physical infrastructure, traffic patterns and procedures, communication data, airspace and navigation information, as well as indicators of activity and usage. For example, the airport facility database 118C may be derived from and is likely a subset of the FAA Airport Facilities database. Updates to the airport facility database 118C may be performed offline at scheduled intervals. However, when critical new information is required between scheduled updates, it may be sent via a dedicated data link 122, such as Notices to Air Missions (NOTAMs) via a FIS-B data link for an aircraft based system, or via the internet, 124 for an airport based system. These live updates may be stored in the NOTAM database 118E. This database may or may not have persistent storage. Information about airport weather is also sent through the FIS-B data link 122 for an aircraft based system, and through the internet 124 for an airport based system. The data is stored in the NOTAM database 118E.

The rules matrix database 118D may contain information on rules used to assess the viability of various future flight paths to and from a runway at an airport, and to construct detailed four-dimensional trajectories for those future flight paths. Updates to the rules matrix database 118D may be performed offline at scheduled intervals.

The registered aircraft database 118G may contain all registered aircraft that may operate at an airport in which the system is implemented. For example, the registered aircraft database 118G may contain information on all US-registered aircraft for a system operating in the US. It may contain detailed information about specific aircraft. For example, this information may include the aircraft's make, model, and year of manufacture, as well as its gross weight, approach, and departure speeds. Any other relevant aircraft information may be included. Updates to the registered aircraft database 118G may be performed offline at scheduled intervals.

The aircraft tracking conflict database 118F may contain an array of all identified conflicts. Each conflict may include the 4D coordinates of the conflict, the identification of the aircraft involved, the general path variant of each aircraft, and the time the conflict was identified.

The aircraft tracking unit 102 may monitor all aircraft within a specified tracking range using received aircraft state information 120. The tracking range may refer to the distance from either the ownship for an aircraft-based implementation, or the current landing or departing airport for an airport-based implementation. For example, the tracking range may extend to thirty nautical miles from the current location of the ownship or from the airport's current landing or departing airport, depending on where the system is located and implemented.

The aircraft tracking unit 102 may store aircraft state data for all aircraft within a specified tracking range in the aircraft tracking database 118A. Specifically, the aircraft tracking unit 102 may create and update a historical record of latitude, longitude, altitude, timestamp, groundspeed, track, and other relevant information for each monitored aircraft within a predefined range from the time it is first detected until the current time.

The predefined range may be defined as the distance from each ownship for an ownship-based solution, and from the airport for an airport-based solution. If the monitored aircraft is outside the predefined range, its historical record may not be updated. Thus, for a monitored aircraft within the predefined range, its historical record may no longer be updated by the aircraft tracking unit 102 once it is outside the predefined range.

If the historical record for a monitored aircraft has not been updated for a predefined persistence period, the aircraft tracking unit 102 may flush that historical record from the aircraft tracking database 118A.

The aircraft tracking unit 102 may create and update historical records within the aircraft tracking database 118A at a predetermined rate. For example, the aircraft tracking unit 102 may create and update historical records within the aircraft tracking database 118A once per second for each monitored aircraft. If any data within a historical record has not been updated at this specified rate, the aircraft tracking unit 102 may implement an algorithm to linearly interpolate any missing data.

The aircraft tracking unit 102 may determine whether a monitored aircraft has taken off from an airport runway based on an aircraft's historical record and update the airport active runway database 118B accordingly.

For example, the aircraft tracking unit 102 may examine data from a monitored aircraft's historical record to determine whether the aircraft's speed is sufficient for it to be airborne and whether its 4D GPS track correlates with a departure from a runway. If all of these are determined to be true, the aircraft tracking unit 102 may update the airport active runway database 118B to record data corresponding to that monitored aircraft's departure, including the runway name, aircraft identification, takeoff time, takeoff direction, and any other relevant data known to a person of ordinary skill in the art. An aircraft performing an aborted landing would meet the above criteria, and the airport active runway database 118B would be updated to record that the monitored aircraft is taking off from that runway.

The aircraft tracking unit 102 may determine whether a monitored aircraft has landed on an airport runway based on an aircraft's historical record and update the airport active runway database 118B accordingly.

For example, the aircraft tracking unit 102 may examine data from a monitored aircraft's historical record to determine whether the aircraft's speed is insufficient for it to be airborne and whether its 4D GPS track correlates with a landing on the runway. If all of these are determined to be true, the aircraft tracking unit 102 may update the airport active runway database 118B to record data corresponding to that aircraft's landing, including the runway name, aircraft identification, landing time, landing direction, and any other relevant data known to a person of ordinary skill in the art.

The aircraft future path predictor unit 104 may compute a series of 4D future trajectories (e.g., latitude, longitude, altitude, and timestamp) for every monitored aircraft based on its past and present state information. Past state information may be sourced from historical data within the aircraft tracking database 118A. Present state information may be sourced from the most recent entries in the aircraft tracking database 118A. Future 4D trajectories computed by the aircraft future path predictor unit 104 may be stored in the aircraft tracking database 118A.

The aircraft future path predictor unit 104 calculates potential future 4D trajectories by considering each aircraft's position relative to each runway at the airport and its state values (such as track, altitude, groundspeed, change of altitude, and turn rate). It identifies viable paths that allow the aircraft to land on each runway or to depart the airport area during takeoff. These viable paths may not need to rely on predefined specifications indicating which runway or which type of approach or departure an aircraft is attempting. As a result, the aircraft future path predictor unit 104 may account for the future unpredictability of pilots.

The aircraft future path predictor unit 104 may iterate through each of the monitored aircraft, for every runway at the airport, every landing general path variant, every takeoff general path variant, and every special-purpose general path, such as continuation of current path at the airport. Each of these monitored aircraft may be monitored using past and current information in the aircraft tracking database 118A.

Based on the information retrieved during each iteration, the aircraft future path predictor unit 104 uses the monitored aircraft's current location to position it in an element of the runway grid and identify a series of potential general path variants and any special purpose paths that will lead to landing on the specified runway or departing the specified runway's grid. It then uses the viable future path rules in the rules matrix database 118D to analyze the aircraft's state information, identifying the subset of potential general path variants that are viable given the monitored aircraft's current state.

Once the viable future paths have been identified, the aircraft future path predictor unit 104 may calculate a predicted 4D future trajectory for each identified viable future path and store them in the aircraft tracking database 118A. Each predicted 4D trajectory may be constructed using the sequence of instructions specified in the projected path rules for the specific variant in the grid element within the rules matrix database 118D.

The projected path rules may be comprised of a data matrix of landing general path variant data and a data matrix of takeoff general path variant data. Each data matrix may be organized according to the location of airspace elements within a corresponding runway grid. For example, the data matrix indexes may correspond to the X and Y coordinates of the airspace elements within a given grid.

The aircraft future path predictor unit 104 may iterate at a predefined rate to gather relevant state information, determine viable future paths, and calculate 4d trajectories only for identified viable future paths.

The aircraft conflict advisor unit 108 may compare all future 4D trajectories of all monitored aircraft stored in the aircraft tracking database 116A to identify conflicts.

A conflict is defined as a situation where, at some point in time, starting with the current time and going forward, where, for the ownship-based system, another target aircraft gets within a predefined horizontal separation minima and vertical separation minima from ownship, and for an airport based system any two monitored aircraft within any of the airport grids get within a pre-defined horizontal separation minima and vertical separation minima of each other.

There may be multiple sets of separation minima, based on conditions. For example, a standard horizontal separation minima and vertical separation minima for when ownship (for an ownship-based system) is airborne or when either monitored aircraft is airborne in an airport-based system. A different set of values may also be used if the monitored aircraft (ownship for ownship-based systems, and both ships for aircraft-based systems) is at a speed below a defined groundspeed.

Whether a conflict is recognized may also depend on time. The system designer may or may not recognize a conflict and may prioritize them based on how far in the future they are.

When a conflict is detected, the aircraft conflict advisor unit 108 builds and maintains the aircraft tracking conflicts database 118F, which contains all potential conflicts between monitored aircraft. Initially, the aircraft tracking conflicts database 118F is clear. As the aircraft future path predictor unit 104 and the aircraft conflict advisor unit 108 run over time, conflicts are identified and added to the aircraft conflict advisor unit 108. As a conflict is cleared, the entry is removed.

The aircraft conflict advisor unit 108 may operate in two modes, depending on the configuration of the aviation data system 100. In a configuration where the aviation data system 100 is located on the ownship, each predicted future path of the ownship is compared with all other target aircraft in the database for all runways. Accordingly, the aircraft conflict advisor unit 108 examines the future paths of all target aircraft relative to the ownship, generating warnings and alerts if any target aircraft comes within a specified distance of the ownship within a defined future timeframe.

In a configuration where the aviation data system 100 is located within an airport, the aircraft conflict advisor unit 108 compares the future paths of all monitored aircraft and generates warnings and alerts if any monitored aircraft comes within a specified distance of another monitored aircraft within a defined future timeframe.

The aircraft landing and remediation advisor unit 110 tracks aircraft landing on a runway and computes their order of arrival, as defined by the order of aircraft crossing the Runway Threshold Reference line (TR) 214.

For systems located within an ownship, the advisor determines if any target aircraft will approach the runway threshold within a predefined time frame relative to the ownship. If true, and the ownship is following a target aircraft, the advisor may suggest maneuvers that the pilot of the ownship can perform to mitigate a potential conflict. If true and the target aircraft is following ownship, the advisor may alert the pilot of the ownship to the conflict, identify the registration number (N number) and aircraft type of the aircraft, and suggest that the ownship pilot contact the target pilot via radio.

For systems located within an airport, the aircraft landing and remediation advisor unit 110 determines whether two monitored aircraft will approach the runway threshold within a predefined time frame relative to each other and, if so, may report an alarm and recommend maneuvers for the trailing monitored aircraft to mitigate a potential conflict.

The final approach advisor unit 112 monitors the future 4D trajectory flight path of a monitored aircraft during its final approach. A final approach may be determined when the state information stored in the aircraft tracking database 116A shows that the aircraft is within a straight in general path area 226 of a runway grid and that the monitored aircraft's future 4D trajectory, as determined by the aircraft tracking database 116A may be on a track between 100° and 260° (assuming runway heading is 180°) in the straight in general path area.

If there is a parallel runway and the monitored aircraft's current position, as determined by the aircraft tracking database 116A (regardless of its current vector), is beyond the edge of the landing runway, on the side of the parallel runway, an alarm may be triggered to report that the monitored aircraft is encroaching on the parallel runway.

As the monitored aircraft approaches the landing runway, the final approach advisor unit 112 may issue an alert if the monitored aircraft's 4D trajectory is not headed within 10 degrees of the landing runway when it is beyond a defined distance from the runway, and within 3 degrees if it is closer to the runway.

The wake turbulence advisor unit 116 provides warnings to monitored aircraft about possible wake turbulence from large aircraft that will cross the monitored aircraft's path in the future. The wake turbulence advisor classifies a heavy aircraft as any monitored aircraft whose gross weight, as extracted from the registered aircraft database 116G, may exceed a threshold weight.

For systems located within an ownship, the wake turbulence advisor unit 116 scans the aircraft tracking database 118A for both historical and future 4D trajectory paths. For each heavy aircraft identified, the wake turbulence advisor unit 116 examines the future 4D trajectory of the ownship's declared general path to its designated runway for landing, and the ownship's declared general path until it exits the runway grid for takeoff. At each point along the projected 4D trajectory of ownship, the wake turbulence advisor unit 116 determines whether the heavy aircraft has come, or will come, within a specified horizontal distance and within a specified vertical distance above the ownship, within a set number of seconds before the ownship crosses that point. If the heavy aircraft is within the specified range and time, an alert about potential wake turbulence will be sent to the aircraft display advisor unit 114.

For systems located within an airport, the wake turbulence advisor unit 116 scans the aircraft tracking database 118A for both historical and future 4D trajectory paths, specifically looking for heavy aircraft. For each identified heavy aircraft, the wake turbulence advisor unit 116 examines the future paths of all other monitored aircraft within the airport's runway grids. At each point along each projected 4D trajectory of monitored aircraft, the wake turbulence advisor unit 116 determines whether the heavy aircraft has or will come within a specified horizontal distance, as well as a specified vertical distance above the monitored aircraft, within a set number of seconds before the monitored aircraft crosses that point. If the heavy aircraft falls within the specified range and time, a potential wake turbulence alert is sent to the aircraft display advisor unit 114.

The aircraft display advisor unit 114 interacts with both audio and graphical human interfaces to deliver various levels of warnings and alerts. One possible implementation may include variations of aural, voice, and graphical outputs. Inputs to the aircraft display advisor unit 114 may come from a keyboard, touchscreen, or voice commands. Additionally, the aircraft display advisor unit 114 may provide graphical context information about all aircraft in the vicinity of the ownship or the airport.

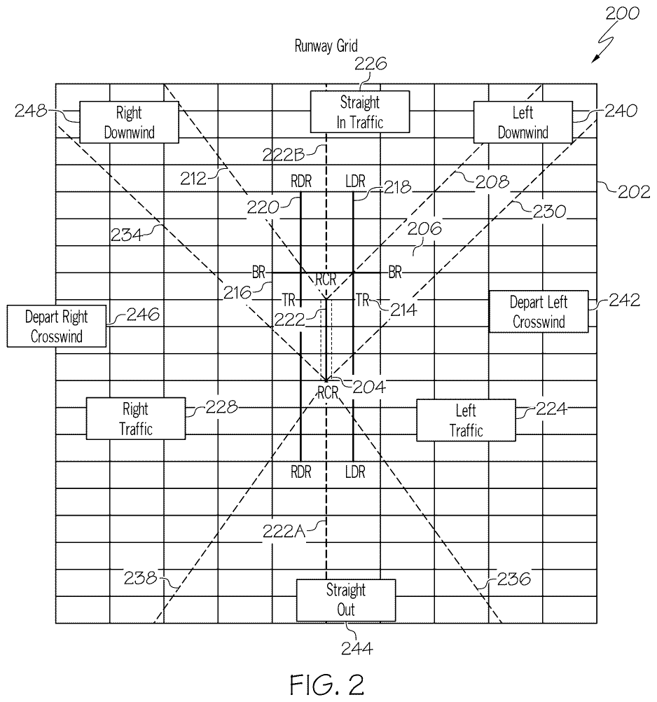

FIG. 2 is a schematic representation 200 of a runway grid 202 as implemented within a system for traffic separation assistance in the vicinity of an airport, as disclosed herein.

As shown in FIG. 2, the schematic representation 200 includes a runway grid 202 overlayed on a runway 204 and defining three designated landing general paths 224, 226, 228 leading to the runway 204, and five designated takeoff general paths 240, 242, 244, 246, 248.

Specifically, a landing left general path 224 to the runway 204 is defined within the runway grid 202 in the area between landing grid lines 208 and heading clockwise to 222A. A landing right general path 228 to the runway 204 is defined within the runway grid 202 in the area between landing grid lines 222A and heading clockwise towards 212. A landing straight-in general path 226 to the runway 204 is defined within the runway grid 202 in the area between landing grid line 212 and heading clockwise to the landing grid line 208. All landing grid lines originating from the approach end 204A of the runway 204.

Additionally, a departing left downward general path 240 is defined within the runway grid 202 between the departing grid lines 222B and heading clockwise to 230. A departing left crosswind path 242 is defined within the runway grid 202 between the departing grid lines 230 and heading clockwise to 236. A departing straight-out general path 244 is defined within the runway grid 202 between the departing grid lines 236 and heading clockwise to 238. A departing right crosswind general path 246 is defined within the runway grid 202 between the departing grid lines 238 and heading clockwise to 234. A departing right downwind path 248 is defined within the runway grid 202 between grid lines 234 and heading clockwise to 222B. All departing grid lines originating from the departing end 204B of the runway 204.

The runway grid 202 may be a two-dimensional grid comprising equally sized elements that partition the airspace surrounding the runway 204 into specific grid elements 206.

The runway grid also has five reference lines. There are two horizontal reference lines, a Base Reference 216 (constant Y axis, which may=1) and a Threshold Reference (TR) 214 (constant Y axis=0). There are three vertical reference lines, namely a Left Downwind Reference (LDR) 218 (constant X, which may=1), a Runway Centerline Reference (RCR) 222 (constant X=0), and a Right Downwind Reference (RDR) 220 (constant X, which may=−1).

The runway grid 202 is oriented on the runway 204 such that it is aligned with the direction of the landing and departing runway 204. As shown in FIG. 2, the origin (grid element 0,0) of the runway grid 202 is positioned at the landing end of the runway 204, where a Threshold Reference line (TR) 214 and a Runway Centerline Reference Line (RCR) 222 of the runway 204 intersect. For example, the runway grid 202 index at point 0, −1 is aligned on the Runway Centerline Reference (RCR) 222 of the runway 204, one grid unit down the Threshold Reference line (TR) of the runway. Similarly, the runway grid 202 index at points 0 and 1 is aligned with the Runway Centerline Reference line 222 of runway 204, one grid unit above the Threshold Reference line (TR) of the runway. Every runway 204 at an airport may have a unique runway grid 202 with its origin positioned at the intersection of the Threshold Reference line (TR) 214 and a Runway Centerline Reference line (RCR) 222 of the runway 204, and its orientation aligned with the direction of the landing and departing runway 204.

The size and resolution of the runway grid 202 and the corresponding size of each of the specific grid elements 206 may be set to establish a fixed common measure of airspace distance within the runway grid 202. The size and resolution of the runway grid 202 may be set to provide a mechanism for accurately predicting a plane's future route based on its geographic position relative to the runway 204 and to predict this route far enough ahead of the actual aircraft landing or departing the runway 204 to be able to give ample warning before a conflict.

The size of the runway grid 202 itself may be set to cover a large enough area surrounding the runway 204 to give the aviation data system 100 sufficient time to provide advanced warning of a conflict. However, the size of the runway grid 202 may not be set so large as to create too many grid elements. For example, the size of the runway grid may be set to cover at least 25,000 feet on either side of the runway, 25,000 feet from the touchdown end of the runway to beyond the departure end of the runway, and 50,000 feet in front of the touchdown zone of the runway 204.

To ensure maximum flexibility and accuracy in future path 4D trajectories, the size of each specific grid element 206 must be confined. The size must be small enough to allow for diversity in viability and future path rules for aircraft in different geographic positions relative to the runway, as all aircraft in one element have identical viability and future path rules. However, if the grid elements are too small, it will increase the total number of grid elements needed, leading to a greater number of viable and projected path rules in the rules matrix database 118D. For example, each side of a grid element may be set to cover 2500 feet of airspace within the runway grid 202.

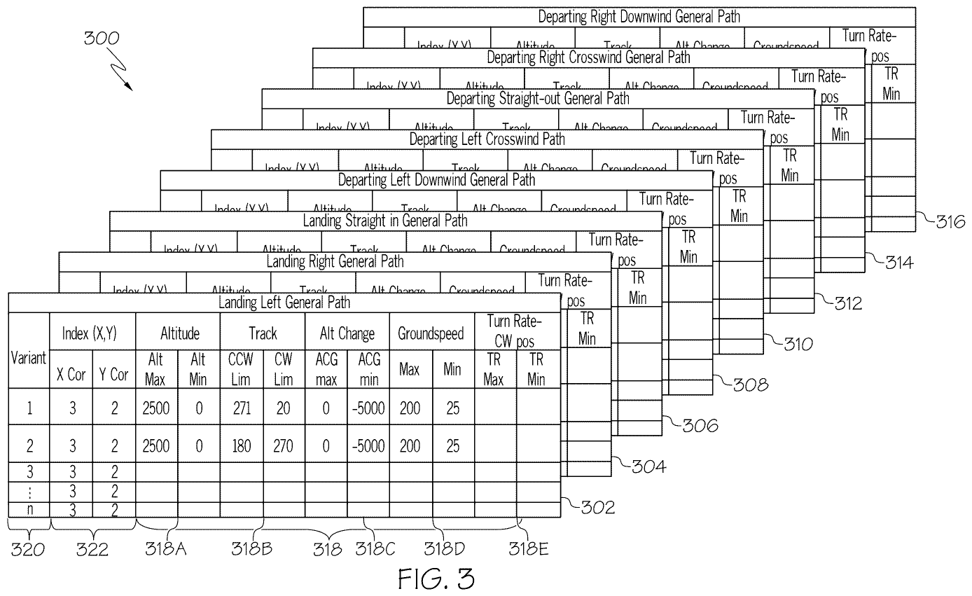

FIG. 3 is a representation of the viable future paths rules matrix 300 for traffic separation assistance in the vicinity of an airport, as disclosed herein.

The viability rules, which are unique for each grid element, determine whether an aircraft can safely fly a specific general path variant within that grid. This determination is made by comparing the aircraft's state information, such as its current altitude, track, change in altitude, groundspeed, and turn rate, against a set of specifications for the particular general path variant. For instance, if an aircraft's current state (the above items) support safe navigation of the specific general path variant, then the variant is considered viable. Conversely, if any of the aircraft's state is deemed unsafe for that specific variant, such as a heading in the wrong direction, or other unsafe state conditions, the variant is classified as nonviable. If a general path variant is determined to be viable, a future trajectory is constructed from a sequence of instructions.

As shown in FIG. 3, the viable future paths rules matrix 300 may comprise an individual matrix for each of the general paths defined within the runway grid 202 for landing on the runway 204, and for each of the general paths defined within the runway grid for departures from the runway 204.

Specifically, for landings on the runway 204, a viable future paths rules matrix 302 for the landing left general path 224, a viable future paths rules matrix 304 for the landing right general path 228, and a viable future paths rules matrix 306 for the landing straight general path 226.

Additionally, for departure from the runway 204, a viable future paths rules matrix 308 for the departing left downwind general path 240, a viable future paths rules matrix 310 for the departing left crosswind path 242, a viable future paths rules matrix 312 for the departing straight-out general path 244, a viable future paths rules matrix 314 for the departing right crosswind general path 246, and a viable future paths rules matrix 316 for the departing right downwind path 248.

The viable future path rules matrix for each landing general path variant and each departing general path variant may contain similar types of state information, each customized for a specific general path variant. FIG. 3 displays a representation of the types of state information comprising a viable future paths rules matrix.

In FIG. 3, the viable future paths rules matrix 302 for the landing left general path 224 lists state information 318 for a plurality of specific variant paths 320 applicable to a specific grid element 206 within the landing left general path 224 of the runway grid 202.

Looking at the viable future paths rules matrix 302 for the landing left general path 224 in FIG. 3, the viable future paths rules matrix 302 may be configured to include columns for variant numbers 320, runway grid indexes 322, and state information 318. Each row provides state information 318 corresponding to a specific variant path 320 applicable to a specific grid element 206 within the landing left general path 224 of the runway grid 202.

The variant numbers column 320 identifies a specific variant path 320 within the landing left general path 224 of the runway grid 202. There may be a fixed number of variant paths (designated as n in FIG. 3) for each specific grid element 206 identified in the runway grid index 322.

The runway grid index 322 column identifies the specific grid element 206 within the landing left general path 224 of the runway grid 202 to which the viable future paths rules matrix 302 applies.

The state information 318 columns identify flight characteristics associated with a specific variant path 320 within the designated runway grid index 322. The state information 318 may include altitude 318A, track 318B, altitude change 318C, groundspeed 318D, and turn rate 318E. The state information 318 may include any additional relevant flight characteristics known to a person of ordinary skill in the art.

The range values provided in FIG. 3 may all be with reference to the coordinate system of the runway grid 202. For example, the altitude range, track range, altitude change, groundspeed range, and turn rate are all provided relative to the runway grid.

For some state information 318, a range of values may be provided, while for others, no values may be available. A comparison is performed to determine whether the most recent monitored state information collected by the aircraft tracking unit 102 falls within the provided ranges for the corresponding state information 318 in the viable future paths rules matrix 302. If the monitored aircraft state conditions fall within the range of every state information 318 in the viable future paths rules matrix 302 for which a range has been provided, then the corresponding variant path 320 is deemed to be a viable future path. If a range for specific state information 318 in the viable future paths rules matrix 302 is not provided for a specific variant path 320, it is assumed to be satisfied. If no ranges are provided for all the state information 318 in the viable future paths rules matrix 302 for a specific variant path 320, that variant path is deemed to never be a viable future path.

For example, assume that the state information collected by the aircraft tracking unit 102 of an aircraft currently within the airspace corresponding to grid element 206 at grid index 3,2 of the runway grid consists of a grid altitude of 800 feet, a track of 340 degrees, an altitude change gradient of −140 feet per nautical mile, and a groundspeed of 80 knots.

Looking at the viable future paths rules in FIG. 3, the collected state conditions all fall within the corresponding ranges provided in the viable future paths rules matrix 302 for altitude, track, altitude change gradient, and groundspeed for variant path 1. Since no range is provided for the turn rate for variant path 1, it is assumed that this state condition is satisfied. Accordingly, variant path 1 will be considered a viable future path for which a future route will be calculated.

Variant path 2 is determined not to be a viable future path because the collected track value of 340 degrees falls outside the range provided in the viable future paths rules matrix 302 for the variant path.

Variant path 3 is determined not to be a viable future path because ranges are not provided for any of the state conditions for variant path 3.

Accordingly, the aircraft future path predictor unit 104 will calculate a 4D trajectory only for variant future path 1, and not for future variant paths 2 and 3.

Every specific grid element 206 in the runway grid 202, regardless of where it is, will have a set of viability rules for every general path variant.

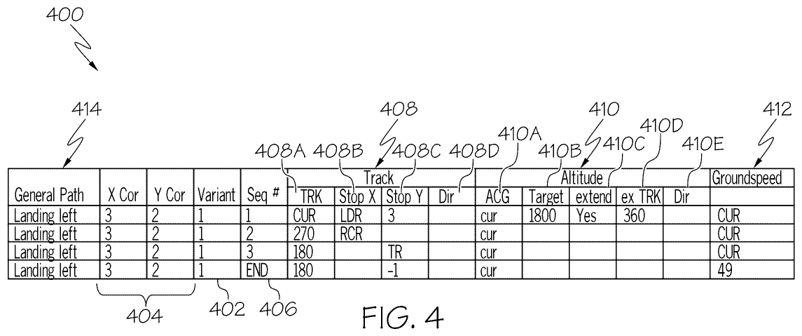

FIG. 4 is a tabular representation of a projected path rules matrix 400 for a future viable path to a landing runway or from a departing runway as implemented within a system for traffic separation assistance in the vicinity of an airport, as disclosed herein.

The projected path rules matrix 400 may consist of a sequence of instruction steps used by the aircraft future path predictor unit 104 to calculate a 4D trajectory to the runway 204 for landing, or from the runway for takeoffs, for each previously determined future viable path. The calculated 4D trajectory may comprise a data matrix in the aircraft tracking database 118A, where each entry contains 4 fields: latitude, longitude, altitude, and timestamp. The number of entries is the total number of points in the 4D trajectory.

As shown in FIG. 4, the path rules matrix 400 may define multiple rows of instructions for a specific variant 402 of a general path 414 at a specific grid element 404. Each instruction is identified by a sequence number 406 for the aircraft future path predictor unit 104 to calculate the aircraft's predicted 4D trajectory. For each sequence number instruction 406, the path rules matrix 400 provides information for calculating track 408, altitude 410, and groundspeed 412 for the predicted 4D trajectory.

For example, as represented in FIG. 4, the aircraft future path predictor unit 104 begins execution of the instructions by utilizing the track 408, altitude 410, and groundspeed 412 information corresponding to the first sequence number 406 labeled “1.” It then continues execution with the information defined under the instruction under sequence number 406 labeled “2,” followed by the information defined under the third sequence number 406 labeled “3,” and ultimately concludes with the information defined under the sequence number 406 labeled “END.”

For each instruction in the sequence, the aircraft future path predictor unit 104 calculates the 4D trajectory in multiple steps. The aircraft future path predictor unit 104 first calculates X and Y coordinates and timestamp for trajectory elements going forward in time. In this step, it ignores the altitude 410 section.

As shown in FIG. 4, track 408 information may include track 408A, X-axis stop 408B, Y-axis stop 408C, and direction 408D.

The aircraft future path predictor unit 104 uses the groundspeed 412 (either a specified value or if CUR, either the value used in the prior instruction step, or if this is the first instruction in the sequence, the current state information groundspeed of the aircraft from the aircraft tracking database 118A) combined with the track 408A (either a heading or if CUR, either the value used in the prior instruction step, or if this is the first instruction in the sequence, the current state information track of the aircraft) and computes an X, Y grid position for every timestamp going forward.

For example, with a grid element size of 2500′ per side, an aircraft flying at an groundspeed of 149 Knots (15,000′/min, which is 250′/second), with a due North track (0°), at grid position 1,0, with a timestamp increment of 1 seconds, the aircraft future path predictor unit 104 would calculate future trajectories at grid position 1,0.1 at time=+1, at grid position 1,0.2 at time=+2, grid position 1,0.3 at time=+3, and so on.

The X-axis, Y-axis, and timestamp portion of the instruction sequence step (row in FIG. 4) is completed when the track 408A reaches or goes beyond the Stop X (X-axis stop) 408B or Stop Y (Y-axis stop) 408C, whichever occurs first, or when the aircraft project path exits the runway grid.

The X-axis stop 408B and Y-axis stop 408C stops may be set to coordinates within the runway grid 202 or to special lines identified in the runway grid 202. If either the X-axis stop 408B or the Y-axis stop 408C has already been reached prior to the current instruction (before the current sequence instruction begins), the current instruction ends immediately.

Moreover, if an X-axis stop 408B or Y-axis stop 408C specified in a later instruction is reached before reaching the ones in the current instruction, the aircraft future path predictor unit 104 jumps immediately to that instruction.

When a new instruction requires a change in track 408, a defined constant specifies the turning rate, in degrees per second. For example, the constant may be set to 4.5° per second. Turns need to be included in trajectory calculations. For example, when turning from 90 degrees to 180 degrees at 4.5° per second, the turn will take 20 seconds and should be reflected in the 4D trajectory. The direction 408D designation defines the direction of a turn. In the path rules matrix 400, the direction 408D may be set to CCW to designate a counterclockwise turn or CW to designate a clockwise turn. If the direction 408D designation is left blank, it will default to the direction with the shortest turn.

After completing the X-axis and Y-axis coordinates and timestamp calculations for the current instruction sequence step, the aircraft future path predictor unit 104 then calculates the altitude components of the future trajectory for this instruction. For the current instruction in the sequence, if the altitude change gradient (ACG) 410A calls for a CALC mode, the aircraft future path predictor unit 104 will complete all X-axis, Y-axis, and timestamp calculations for all remaining instructions in the sequence before doing the altitude calculations.

As shown in FIG. 4, the altitude 410 information may include altitude change gradient (ACG) 410A, target altitude 410B, altitude extend designation 410C, extend track 410D, and direction 410E.

The altitude change gradient (ACG) 410A is the change in altitude, measured in feet over 1 nautical mile (6076 feet) of horizontal distance traveled. In the path rules matrix 400, the altitude change gradient (ACG) 410A may be set to CUR or to CALC. CALC mode is used only for landing aircraft, while CUR mode is used for both landing and departing aircraft.

Once CALC mode is specified in a sequence instruction, future sequence instructions must stay with that mode. For CALC mode, execution of this function will be delayed until after all instructions in the sequence have completed processing latitude and longitude coordinates and timestamp 4D trajectory elements.

When the altitude change gradient (ACG) 410A is set to CALC, the aircraft future path predictor unit 104 will take the difference in altitude from the current altitude (either the value used in the prior instruction step, or if this is the first instruction in the sequence, the current state information altitude of the aircraft from the aircraft tracking database 118A) to a grid altitude of zero feet. It will divide that by the total distance the aircraft will travel to cross the Threshold Reference line (TR) 214 to determine the altitude change gradient (ACG) and then use that calculated altitude change gradient (ACG) to calculate a target altitude at each future timestamp point.

The altitude change gradient (ACG) 410A set to CUR can be used for both landing and takeoff future trajectories. For instructions with CUR, altitude processing is performed at each sequence instruction after the X-axis, Y-axis, and timestamp calculations are completed. The aircraft future path predictor unit 104 will use the most recent ACG value from the preceding sequence instruction step, or, if this is the first step, it will use the aircraft state information's current ACG value from the aircraft tracking database 118A for any altitude calculations at each future timestamp.

For landing aircraft, if the altitude change gradient (ACG) 410A is set to CUR, it must also have a specified target altitude 410B. For aircraft taking off, the target altitude 410B is optional. As the aircraft future path predictor unit 104 is computing the 4D trajectory, when the target altitude is reached or surpassed, the altitude change gradient (ACG) is reset to 0 (level flight) for the remainder of the instruction.

For example, if an aircraft is at 1000 feet with an groundspeed of 149 Knots and an ACG of −500 (which, based on speed, translates to −1241 feet per minute or −21 feet per second), and a target altitude of 600 feet, then the calculated 4D trajectory will be an altitude of 1000 feet at time=0, 979 feet at time=1, 958 feet at time=3, and 937 feet at time=4, and so on.

The altitude extend designation 410C may instruct the aircraft future path predictor unit 104 to extend the execution of the current instruction. This may be necessary when an aircraft can't reach the target altitude 410B before hitting the X-axis stop 408B or the Y-stop 408C points in the runway grid 202.

In the path rules matrix 400, if the altitude extend designation 410C is set to “yes,” the aircraft future path predictor unit 104 extends execution of the current instruction beyond the defined stop X 408B or Stop Y 408C point, until the target altitude 410B is reached.

If the altitude extend designation 410C is set to yes, an extend track 410D must be specified to define the track the aircraft must fly after it has encountered the normal end of the instruction (X-axis stop 408B or Y-axis stop 408C point, whichever is encountered first). This can be a numeric track direction or CUR, which extends the current track. The aircraft flies this track until the 4D trajectory altitude equals the target altitude 410B.

When executing an extend track, if a turn is required, the direction 410E determines the turn's direction. In the path rules matrix 400, the direction 410E may be set to CCW to designate a counterclockwise turn or CW to designate a clockwise turn. If the direction 410E designation is left blank, it will default in the direction with the shortest turn.

Once the target altitude 410B is reached, the aircraft future path predictor unit 104 moves to the next instruction.

In the situation where an X-axis stop 408B or Y stop 408C has been encountered before the instruction, or the stop axis for a future instruction has already been encountered, the extend sequencing overrides that, and this instruction is extended until the target altitude has been reached, and then processing continues on the next instruction, or the future instruction.

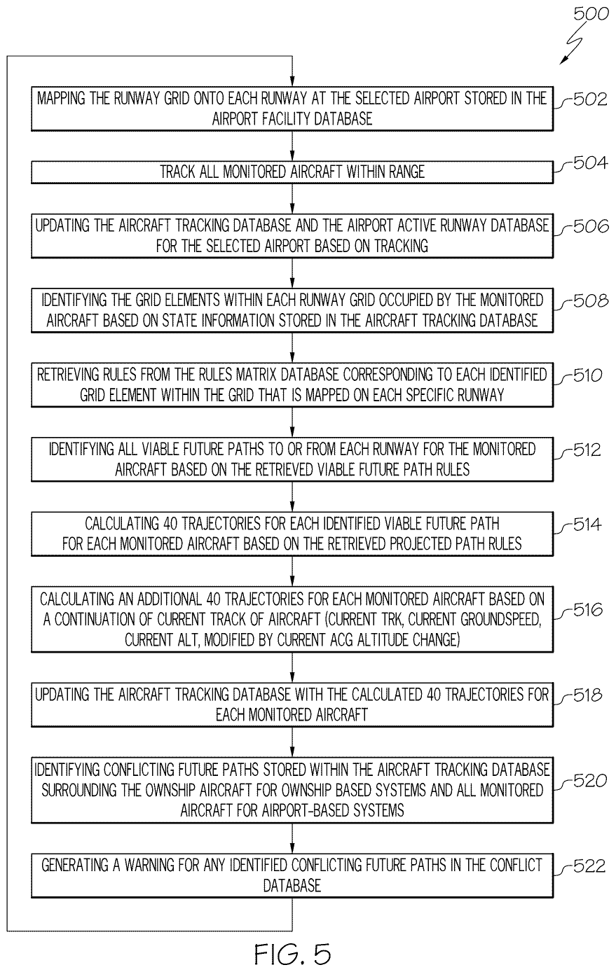

FIG. 5 is a flow diagram of a method 500 for tracking and reporting target aircraft possibly conflicting with an ownship landing at or departing from an airport for an ownship-based system or all monitored aircraft for an airport-based system as implemented within a system for traffic separation assistance in the vicinity of an airport, as disclosed herein.

Method 500 is invoked on a regular basis at a predefined interval. For example, the method 500 may be invoked continuously at an interval of one (1) second.

As shown in FIG. 5, the method 500 begins at step 502 with the aircraft future path predictor unit 104 mapping a runway grid 202 onto each runway at a selected airport. Information on each runway at the selected airport may be retrieved from the airport facility database 118C.

The method 500 continues at step 504 with the aircraft tracking unit 102 tracking all monitored aircraft within a predefined range of the ownship for an ownship-based solution, or the airport for an airport-based solution.

The method 500 continues at step 506 with the aircraft tracking unit 102 updating the aircraft tracking database 118A and the airport active runway database 118B for the selected airport, based on state information for all monitored aircraft.

The method 500 continues at step 508 through 518, where it cycles through every monitored aircraft that is inside any runway grid for any runway at the selected airport. It completes all the steps sequentially for each monitored aircraft before continuing with the next monitored aircraft.

The method 500 continues at step 508 with the aircraft future path predictor unit 104 identifying the grid elements within each runway grid occupied by the monitored aircraft based on state information stored in the aircraft tracking database 118A.

The method 500 continues at step 510 with the aircraft future path predictor unit 104 retrieving rules from the rules matrix database 118D corresponding to each identified grid element within the grid that is mapped on each specific runway.

The method 500 continues at step 512 with the aircraft future path predictor unit 104 identifying all viable future paths to or from each runway for the monitored aircraft based on the retrieved viable future path rules.

The method 500 continues at step 514 with the aircraft future path predictor unit 104 calculating 4D trajectories for each identified viable future path for the monitored aircraft based on the retrieved projected path rules. The 4D trajectories terminate as defined by the future path predictor unit 104.

The method continues at step 516 with the aircraft future path predictor unit 104 calculating an additional 4D trajectory for the monitored aircraft based on a continuation of current track of aircraft (current TRK, current Groundspeed, current ALT, modified by current ACG altitude change). This path handles the case where the monitored aircraft is just passing through the airport area. This 4D trajectory ends when the monitored aircraft departs all airport runway grids.

The method 500 continues at step 518, with the aircraft future path predictor unit 104 updating the aircraft tracking database 118A with the calculated 4D trajectories for the monitored aircraft.

The method 500 continues at step 520 after it processed steps 508 to 518 for each monitored aircraft, with the aircraft conflict advisor unit 108 identifying conflicting future 4D Trajectories stored in the aircraft tracking database 118A surrounding the ownship aircraft for ownship based systems and all monitored aircraft for airport based systems, and entering them into a conflict database 118F.

Lastly, the method 500 ends at step 522 with the aircraft conflict advisor unit 108 generating a warning for any identified conflicting future paths in the conflict database 118F.

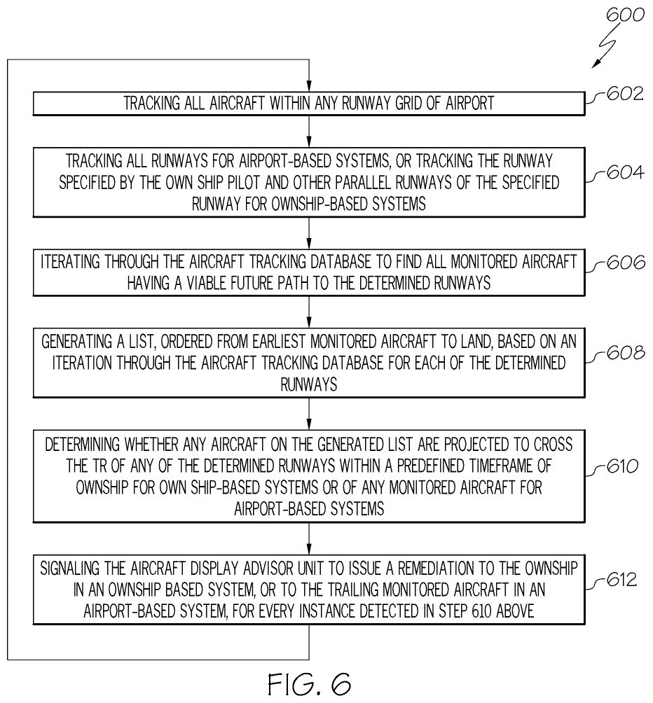

FIG. 6 is a flow diagram of a method 600 for tracking, sequencing and providing guidance to an ownship landing at an airport for an ownship-based system or all monitored aircraft landing at the airport for an airport-based system as implemented within a system for traffic separation assistance in the vicinity of an airport, as disclosed herein.

As shown in FIG. 6, the method 600 begins at step 602 with the aircraft tracking unit 102 tracking all aircraft within any runway grid of the airport.

The method 600 continues at step 604, with the aircraft landing and remediation advisor unit 110 tracking all runways for airport-based systems or tracking the runway specified by the ownship pilot and any parallel runways for ownship-based systems.

The method 600 continues at step 606 with the aircraft landing and remediation advisor unit 110 iterating through the aircraft tracking database 118A to find all monitored aircraft having a viable future path to each of the determined runways.

The method 600 continues at step 608 with the aircraft landing and remediation advisor unit 110 generating a list for each determined runway, ordered from the earliest monitored aircraft to land, based on an iteration through the aircraft tracking database 118A for each determined runway. The time-ordered list may be based on the projected time the monitored aircraft will cross the determined runway's Threshold Reference line (TR) 214.

The method 600 continues at step 610 with the aircraft landing and remediation advisor unit 110 determining whether any aircraft on the generated list are projected to cross the TR of any of the determined runways within a predefined timeframe of ownship for ownship-based systems or of any monitored aircraft for airport-based systems.

The method 600 ends at step 612 with the aircraft landing and remediation advisor unit 110 signaling the aircraft display advisor unit 114 to issue a remediation to the ownship in an ownship-based system, or to the trailing monitored aircraft in an airport-based system, for every instance detected in step 610.

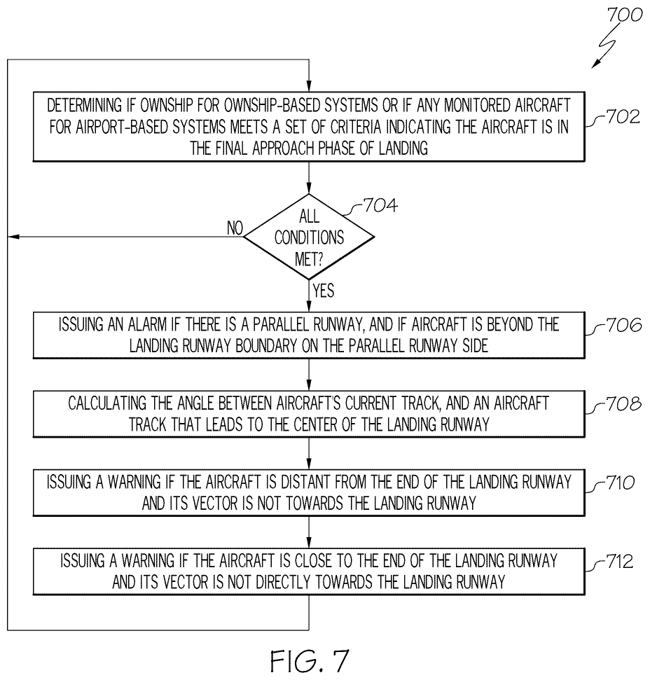

FIG. 7 is a flow diagram of a method 700 for providing final approach guidance to ownship for ownship-based systems or of any monitored aircraft for airport-based systems on the final approach to land on a runway at an airport as implemented within a system for traffic separation assistance in the vicinity of an airport, as disclosed herein.

As shown in FIG. 7, the method 700 begins at step 702 with the final approach advisor unit 112 determining if ownship for ownship-based systems or if any monitored aircraft for airport-based systems meets a set of criteria indicating the aircraft is in the final approach phase of landing. The criteria may include whether the aircraft is within an element of the runway grid 202, within the landing straight-in general path 226 area of the runway grid 202, and whether the aircraft's future 4D trajectory is on a track between 100° and 260° (assuming the runway heading is 180°).

The method 700 continues at step 704 with the final approach advisor unit 112 determining whether the criteria for the final approach to land have been met. If so, the method 700 proceeds to step 706; if not, it loops back to step 702.

The method 700 continues at step 706, with the final approach advisor unit 112 determining whether there is a parallel runway to the landing runway and whether the aircraft's current position is beyond the landing runway's edge on the side of the parallel runway. If true, the final approach advisor signals the aircraft display advisor unit 114 to send an alarm that the aircraft is encroaching on the parallel runway.

The method 700 continues at step 708, with the final approach advisor calculating the angle between the aircraft's current 4D trajectory track and an aircraft track leading to the center of the landing runway (the intersection of lines RCR 222 and TR 214, as shown in FIG. 2).

The method 700 continues at step 710 with the final approach advisor unit 112 signaling the aircraft display advisor, 114, to send a warning indicating the aircraft's future 4D trajectory is off track for landing on the runway, if 1) the above calculated angle is greater than 10° and 2) the aircraft is greater than a defined distance from the end of the runway. The end of the runway is defined as the intersection of the RCR 222 and TR 214 lines.

The method 700 continues at step 712 with the final approach advisor, 112, signaling the aircraft display advisor, 114, to send an alarm indicating the aircraft is off track for landing on the runway if 1) the above calculated angle is greater than 3° and 2) the aircraft is less than or equal to the defined distance from the end of the runway. The end of the runway is defined as the intersection of lines RCR 222 and TR 214, as shown in FIG. 2. The method then returns iteratively to step 702.

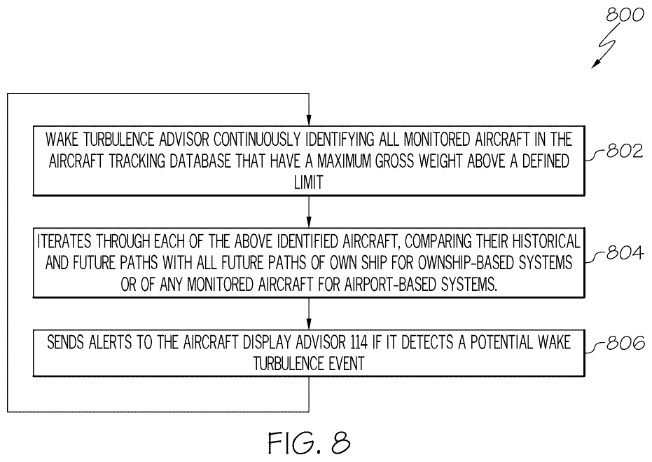

FIG. 8 is a flow diagram of a method 800 for providing a warning to ownship for ownship-based systems or to any monitored aircraft for airport-based systems about possible wake turbulence from large aircraft that will cross the aircraft's path in the future. This system is based, as disclosed herein.

As shown in FIG. 8, the method 800 begins at step 802, with the wake turbulence advisor unit 116 continuously identifying all monitored aircraft in the aircraft tracking database 118A with a maximum gross weight above a defined limit.

The method continues at step 804 with the wake turbulence advisor unit 116 iterating through each of the above-identified aircraft and comparing their historical and future 4D trajectories, as defined in the aircraft tracking database 118A, with all future paths of ownship for ownship-based systems or with the future 4D trajectories of any monitored aircraft for airport-based systems.

The method continues at step 806 with the wake turbulence advisor unit 116 alerting the aircraft display advisor unit 114 if it detects a potential wake turbulence event, as defined in the wake turbulence advisor. The method then returns iteratively to step 802.

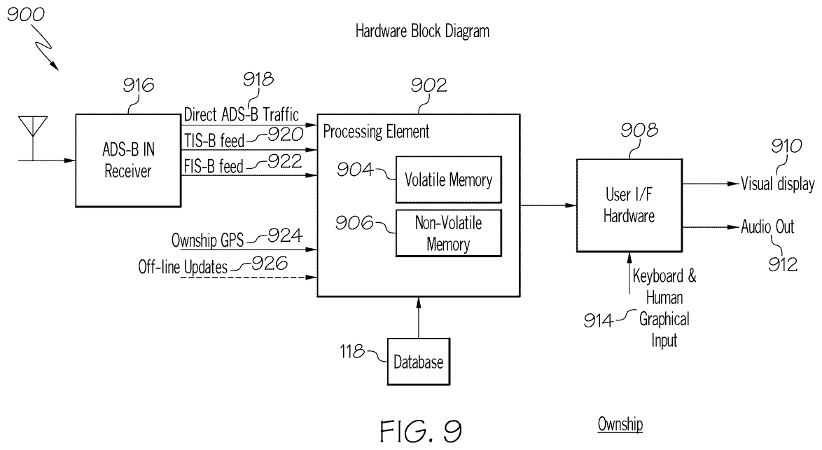

FIG. 9 is a hardware block diagram of an aviation data system 900 located in an ownship and implementing a method for traffic separation assistance in the vicinity of an airport, as disclosed herein.

As shown in FIG. 9, the aviation data system 900 may include a processing element 902 with sufficient processing resources to implement the functional units 102-116 described in this disclosure at a predefined system repetition rate.

For example, given that most of the external traffic sensors have a maximum repetition rate of one (1) second, the system repetition rate may be set to one (1) second.

The processing element 902 may contain volatile memory 904 and non-volatile memory 906 for storing data to and retrieving data from the database 118.

The processing element 902 may interface with user interface hardware 908 that may include functionality supporting a visual display 910, an audio output 912, and human input devices 914, including keyboards, touchscreens, and graphical input devices.

The aviation data system 900 may include an ADS-B in receiver 916 to receive and forward to the processing element 902 positioning information from nearby aircraft feeds 918, a TIS-B feed 920 of traffic information originating from ATC surveillance radar, and an FIS-B feed 922 of flight information system broadcasts providing NOTAM information, which is stored in the NOTAM database 118E. This will include recent updates to the airport facility database 118C.

The processing element 902 may receive an ownship GPS feed 924 providing real-time 3-D GPS information (Latitude, Longitude, and Altitude) about the ownship.

The processing element 902 may receive data from a network 926, such as a local area network (LAN), a wide area network (WAN), or the Internet, via one or more appropriate network or web services, however this is only required when the system is being updated, not while it is in operation.

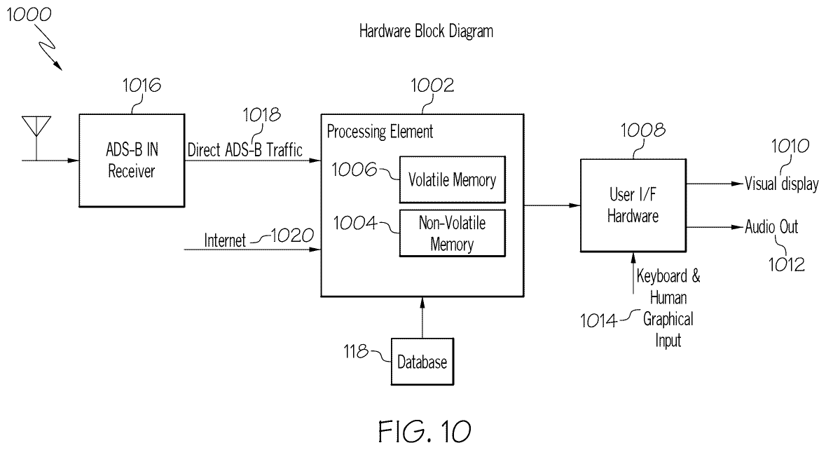

FIG. 10 is a hardware block diagram of an aviation data system 1000 located in an airport and implementing a method for traffic separation assistance in the vicinity of an airport, as disclosed herein.

As shown in FIG. 10, the aviation data system 1000 may include a processing element 1002 with sufficient processing resources to implement the functional units 102-116 described in this disclosure at a predefined system repetition rate.

For example, given that most of the external traffic sensors have a maximum repetition rate of one (1) second, the system repetition rate may be set to one (1) second.

The processing element 1002 may contain volatile memory 1004 and non-volatile memory 1006 for storing data to and retrieving data from the database 118.

The processing element 1002 may interface with user interface hardware 1008 that may include functionality supporting a visual display 1010, an audio output 1012, and human input devices 1014, including keyboards, touchscreens, and graphical input devices.

The aviation data system 1000 may include an ADS-B in receiver 1016 to receive and forward to the processing element 1002 positioning information from nearby aircraft feeds 1018.

The processing element 1002 may receive data from a network, such as a local area network (LAN), a wide area network (WAN), or the Internet, via one or more appropriate network or web services. Data from this feed may be used to update the NOTAM database, 116E, which includes recent updates to the airport facility database 118C. This data source may also be used for system and database updates when the system is not operating. This data source may also be used to access position information on nearby aircraft that aren't reported over the ADS-B traffic link 1018.

The foregoing description discloses only example embodiments. Modifications of the above-disclosed assemblies and methods that fall within the scope of this disclosure will be readily apparent to those of ordinary skill in the art.

This disclosure is not intended to limit the invention to the disclosed particular assemblies and/or methods, but, to the contrary, the intention is to cover all modifications, equivalents, and alternatives falling within the scope of the claims.

1. A method for aircraft traffic separation assistance, comprising:
partitioning airspace surrounding a runway into a runway grid comprising a plurality of discrete, non-overlapping airspace elements;
storing, in a rules matrix database, a set of viable future paths rules and a set of projected path rules associated with each airspace element of the plurality of discrete, non-overlapping airspace elements;
receiving state information for a monitored aircraft, wherein the state information comprises at least position data and track data;
identifying a specific airspace element of the plurality of discrete, non-overlapping airspace elements that the monitored aircraft occupies based on the state information;
retrieving, from the rules matrix database, the set of viable future paths rules and the set of projected path rules associated with the specific airspace element;
applying the set of viable future paths rules to the state information to determine a plurality of viable path variants for the monitored aircraft;
for each viable path variant of the plurality of viable path variants, applying the set of projected path rules to construct a corresponding four-dimensional trajectory, thereby generating a plurality of four-dimensional trajectories for the monitored aircraft;
comparing the plurality of four-dimensional trajectories for the monitored aircraft with four-dimensional trajectories generated for other monitored aircraft to identify a conflict, wherein the conflict comprises a predicted violation of separation minima; and
generating an alert in response to identifying the conflict.

2. The method of claim 1, wherein the state information further comprises one or more of groundspeed, climb gradient, descent gradient, altitude, and turn rate.

3. The method of claim 1, wherein the state information is received from one or more of an Automatic Dependent Surveillance-Broadcast receiver, a Traffic Information Service-Broadcast receiver, and a Global Positioning System receiver.

4. The method of claim 1, wherein the set of viable future paths rules comprises criteria for assessing path variant viability, the criteria comprising one or more of a track angle range, an altitude range, an altitude change gradient, and a groundspeed range.

5. The method of claim 1, wherein the plurality of viable path variants comprises one or more of a left corridor path, a straight-in approach path, and a right corridor path.

6. The method of claim 1, wherein each four-dimensional trajectory of the plurality of four-dimensional trajectories comprises a sequence of points, each point comprising a predicted position and a corresponding timestamp.

7. The method of claim 1, wherein the separation minima comprise a horizontal separation threshold and a vertical separation threshold.

8. The method of claim 1, further comprising: calculating an additional four-dimensional trajectory based on a continuation of a current track of the monitored aircraft.

9. The method of claim 1, further comprising:
updating an aircraft tracking database with the state information and the plurality of four-dimensional trajectories for the monitored aircraft.

10. The method of claim 1, wherein the receiving, identifying, retrieving, applying, and comparing are performed iteratively at a predetermined frequency.

11. The method of claim 1, further comprising: providing final approach guidance comprising a warning for encroachment on a parallel runway or deviation from a runway centerline.

12. The method of claim 1, further comprising: issuing a wake turbulence alert when a predicted path of a first aircraft intersects a recent path of a second aircraft, wherein the second aircraft is classified as a heavy aircraft.

13. A system for aircraft traffic separation assistance, comprising:
a processor; and
a memory storing instructions that, when executed by the processor, cause the system to:
define a runway grid comprising a plurality of discrete, non-overlapping airspace elements partitioning airspace surrounding a runway;
maintain a rules matrix database storing, for each airspace element of the plurality of discrete, non-overlapping airspace elements, a set of viable future paths rules and a set of projected path rules;
receive state information for a monitored aircraft, wherein the state information comprises at least position data and track data;
determine a specific airspace element of the plurality of discrete, non-overlapping airspace elements occupied by the monitored aircraft based on the state information;
retrieve, from the rules matrix database, the set of viable future paths rules and the set of projected path rules corresponding to the specific airspace element;
apply the set of viable future paths rules to the state information to identify a plurality of viable path variants;
for each viable path variant of the plurality of viable path variants, apply the set of projected path rules to generate a corresponding four-dimensional trajectory, thereby producing a plurality of four-dimensional trajectories for the monitored aircraft;
compare the plurality of four-dimensional trajectories for the monitored aircraft against four-dimensional trajectories produced for other monitored aircraft to detect a conflict, wherein the conflict comprises a predicted violation of separation minima; and
generate an alert upon detection of the conflict.

14. The system of claim 13, wherein the system is configured as an ownship-based system installed in an aircraft, and wherein the state information is received from a Global Positioning System receiver for the aircraft and from an Automatic Dependent Surveillance-Broadcast receiver for other aircraft.

15. The system of claim 13, wherein the system is configured as an airport-based system installed at a ground-based facility, and wherein the system monitors a plurality of aircraft within a vicinity of an airport.

16. The system of claim 13, wherein the memory further stores an aircraft tracking database configured to maintain current state and historical state for each monitored aircraft.

17. The system of claim 13, wherein the memory further stores one or more of an airport active runway database, an airport facility database, and a registered aircraft database.

18. The system of claim 13, wherein the set of viable future paths rules comprises criteria comprising one or more of a track angle range, an altitude range, an altitude change gradient, and a groundspeed range.

19. The system of claim 13, wherein the plurality of four-dimensional trajectories comprises up to twenty five distinct trajectories for the monitored aircraft at a given time.

20. The system of claim 13, wherein the instructions further cause the system to provide one or more of landing sequencing assistance, final approach guidance, and wake turbulence alerts.
